(19) United States
(12) Patent Application Publication
(10) Pub. No.: US 2019/0268991 A1
(43) Pub. Date: Aug. 29, 2019

(54) ADJUSTABLE LIGHT APPARATUS

(71) Applicant: LEEDARSON AMERICA INC., Smyrna, GA (US)

(72) Inventor: Yongchuan Li, Smyrna, GA (US)

(21) Appl. No.: 15/906,947

(22) Filed: Feb. 27, 2018

(51) Int. Cl. H05B 33/08; H05B 37/02; F21V 23/00

(52) U.S. Cl. CPC H05B 33/0857; F21V 23/003; H05B 37/02

(57) ABSTRACT

An adjustable light apparatus includes a first light source, a second light source, a control circuit and a tuning circuit. The first light source and the second light source have different optical characteristic. For example, the first light source and the second light source have different color temperatures. The control circuit is coupled to the first light source and the second light source to separately turning on or turning off the first light source and the second light source according to control signals supplied by the tuning circuit.

### FIELD OF INVENTION

The present invention is related to an adjustable light apparatus and more particularly related to a signal driven adjustable light apparatus.

### BACKGROUND

Light apparatuses are widely used in human life. With the current LED (Light Emitted Diode) technologies, light apparatuses have much better power efficiency and stability compared with past light technology.

Nevertheless, light source is critical to provide living quality of an environment. Specifically, for different applications and different environment, different light requirements may be needed to optimize the light performance. Therefore, it is always important and helpful to discover new needs and find a novel technology solution to solve its technical problems.

### SUMMARY

The present invention provides various embodiments of adjustable light apparatuses. In first embodiment, an adjustable light apparatus includes a first light source, a second light source, a control circuit and a tuning circuit. The first light source and the second light source have different optical characteristic. For example, the first light source and the second light source have different color temperatures. The control circuit is coupled to the first light source and the second light source to separately turning on or turning off the first light source and the second light source according to control signals supplied by the tuning circuit.

Specifically, the control circuit is coupled to the first light source and the second light source. The control circuit has a first control gate and a second control gate respectively connected to a first power source and a second power source. The first power source supplies power to the first light source when the first control gate is turned on. The second power source supplies power to the second light source when the second control gate is turned on. The tuning circuit have multiple settings corresponding to different duty cycles for turning on and turning off the first control gate and the second control gate to generate different mixing optical characteristic of the first light source and the second light source.

Please be noted that the first power source and the second power source may be two distinct power sources but may also refer to two parts of one physical power source. In addition, the first power source and the second power source may even be referred to the same power source. In one embodiment, for example, the first light source and the second light source are not turned on at the same time. In other words, for any moment, only one light source is turned on and therefore a single power source may be used as the first power source and the second power source alternatingly.

In one embodiment, the first light source and the second light source are LED (Light Emitted Diode) modules, e.g. a LED chip or a module with multiple LED chips. The first light source and second light source may have different color temperatures. By adjusting the turn-on to turn-off ratio of the first light source corresponding to the second light source therefore may change the visual effect of mixing color temperature. Color mixing may also be used with the technical solutions mentioned in this disclosure.

In one embodiments, the first light source and the second light source respectively have multiple LED modules arranged with an interlaced pattern to each other so that when the first light source and the second light source may provide a more stable mixing effect.

In one embodiment, the first control gate and the second control gate are MOSFET switches respectively receiving a first control signal and a second control signal from the tuning circuit to turn on or to turn off the first light source and the second light source.

In one embodiment, when the first light source is turned on, the second light source is turned off. In addition, when the second light source is turned on the first light source is turned off.

In one embodiment, the first control signal and the second control signal are PWM (Pulse Width Modulation) signals provided by the tuning circuit. PWM, or pulse-duration modulation (PDM), is a modulation technique used to encode a message into a pulsing signal. The PWM signal is a series of pulses. For each pulse (i.e., each period or cycle), the pulse includes a portion of “high” signal and a portion of “low” signal. In one embodiment, the time period may be 1/1000 second between two consecutive high levels of the PWM signal.

In PWM case, the first control signal may refer the high level as turn-on while the second control signal may refer the low level as turn-on. In addition, the first control signal may refer the low level as turn-off while the second control signal may refer the high level as turn-off. By disposing an inverter or related circuit, the first control signal and the second control signal may have the same signal source, e.g. a PWM signal. Please be noted, however, such configuration is only one of the methods to implement the present invention and therefore, the present invention is not limited by such implementation.

In one embodiment, there are more than three settings, each setting corresponding to a different duty cycle with different turn-on by turn-off ratios for the first control signal and the second control signal. For example, the tuning circuit has a switch selectively connected to one of five resistors to construct one of five selective electrical signal values to generate a corresponding PWM signal from five options to control the first light source and the second light source. In such example, there are five settings, which means the first light source and the second light source may be controlled to generate five different optical characteristics, e.g. five different color temperatures.

In some other embodiments, the tuning of the setting may be continuous, instead of selection from several discrete options. For example, a dimmer, e.g. along with an adjustable resistor, may be used to generate a corresponding voltage provided to a PWM generator to generate an associated PWM signal over a continuous range.

In one embodiment, the adjustable light apparatus may include an operation switch sending a tuning operation of a user to the tuning circuit to change the mixing optical characteristic of the first light source and the second light source. For example, a dimmer that is operable by a user may be used to select a setting, and the dimmer, like a rotatable button, may be connected to the tuning circuit to change the setting of driving the first light source and the second light source.

In addition to the first light source and the second light source, in other embodiments, there may be other light sources disposed. For example, a third light source, or even more, may be disposed along with the first light source and the second light source. In such case, the first light source, the second light source, and the third light source may have different color temperatures. Under different settings, the first light source, the second light source and the third light source may be turned sequentially with different time period ratios to generate a different overall color temperature.

In one embodiment, the adjustable light apparatus has a downlight housing for disposing the first light source, the second light source, the control circuit and the tuning circuit. Such downlight housing may include a reflector, a heat sink, a driver circuit, and other corresponding components to be installed on a ceiling cavity. On such housing, there may be a mechanic switch, e.g. an adjustable lever, for a user to slide to set a corresponding setting for generating a different optical characteristic, e.g. a different color temperature. Such mechanic switch may be combined with associated components to instruct the tuning circuit to change the settings of the tuning circuit.

In one embodiment, the adjustable light apparatus has a wireless circuit connected to the tuning circuit for receiving a control instruction from an external device to change the setting of the tuning circuit. For example, a user may use a Wi-Fi device or a Bluetooth device on a mobile phone to send a control signal to the wireless circuit of the adjustable light apparatus to control the tuning circuit to change a desired setting to get a desired overall optical characteristic of the adjustable light apparatus.

In one embodiment, the tuning circuit and the control circuit are integrated in an integrated chip mounted on a circuit board connected to a heat sink. These circuits may generate massive heat and such arrangement may help lengthen the life span and increase system liability.

As mentioned above, there may be more than one optical characteristic to be mixed. For example, the optical characteristic may include color spectrum distribution. In other words, the first light source and the second light source may emit different light colors. By adjusting their turn-on and turn-off ratio may be used to generate a different color effect. In addition to color, luminance strength may also be a factor to be adjusted. For example, the first light source and the second light source may have different luminance levels, e.g. one emits brighter and consumes more power than the other. By adjusting to different settings, users may easily get the desired light effect they need.

In one embodiment, the turn-on periods of the first light source and the second light source are partially overlapped. In such case, the first light source and the second light source may have a common turn-on period instead of a strict alternating pattern. Such design may increase a better visual effect. In such design, certain capacitor may be used to store the increased power source to keep the overall power source not varying too much.

In one embodiment, there may be a time gap between turn-on periods of the first light source and the second light source. For example, when the first light source is turned off, there is a time gap before the second light source is turned on. Such time gap may help keep the power source stable, avoiding undesired peak to damage the power circuit.

In one embodiment, the settings are stored in a table of the tuning circuit and the table is adjustable. For example, the tuning circuit has a corresponding memory unit for storing optional values of the settings. A designer may change the values of the memory unit to change a different value. In such design, a common configuration may have better flexibility. For example, light apparatuses sold to different regions, having different needs and requirements, may use the same hardware settings but loaded with different setting values.

In one embodiment, the first light source and the second light source may not need to be always turned on and then turn off sequentially. For example, the first light source may be kept turned on. By changing the turn-on periods of the second light source, the overall optical characteristic, like color temperature, may still be adjusted under different settings.

In one embodiment, when one of the first light source and the second light source is damaged, the other light source may be kept turned on. In other words, the other light source may be used a redundant backup solution even when one light source is damaged. In such design, an operable switch or an automatic sensor may be used for the tuning circuit to operate under predetermined circuit logic.

### BRIEF DESCRIPTION OF DRAWINGS

FIG. 1 is a schematic diagram of circuit structure of a first embodiment of an adjustable light apparatus.

FIG. 2 illustrates a control timing diagram in a preferred embodiment using PWM.

FIG. 3 illustrates a switch for providing five settings in an adjustable light apparatus.

FIG. 4 illustrates a partial circuit diagram for implementing the control and power supply functions.

FIG. 5 illustrates three different settings under PWN signals.

FIG. 6 illustrates a downlight embodiment that is adjustable.

### DETAILED DESCRIPTION

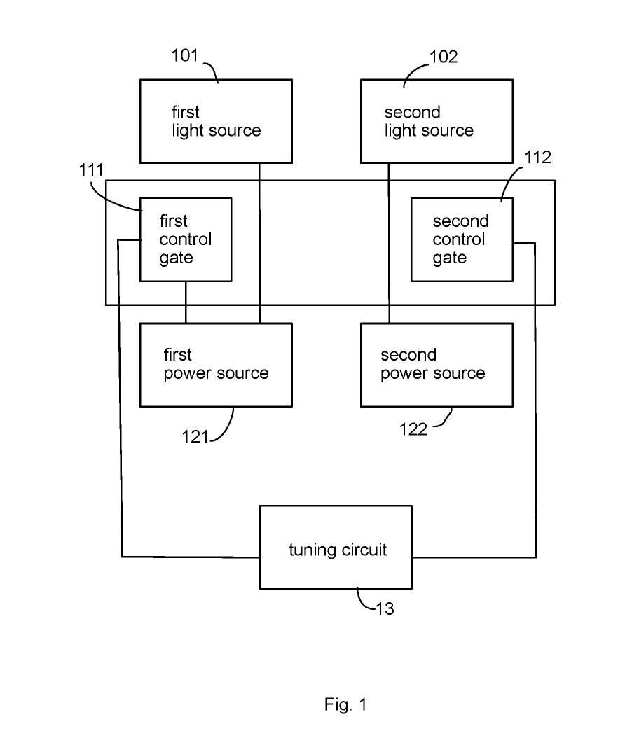

Please refer to FIG. 1, which illustrates an adjustable light apparatus embodiment. In FIG. 1, the adjustable light apparatus includes a first light source 101, a second light source 102, a control circuit and a tuning circuit 13. The first light source 101 and the second light source 102 have different optical characteristic. For example, the first light source 101 and the second light source 102 have different color temperatures. The control circuit is coupled to the first light source 101 and the second light source 102 to separately turning on or turning off the first light source 101 and the second light source 102 according to control signals supplied by the tuning circuit 13.

Specifically, the control circuit is coupled to the first light source 101 and the second light source 102. The control circuit has a first control gate 111 and a second control gate 112 respectively connected to a first power source 121 and a second power source 122. The first power source 121 supplies power to the first light source 101 when the first control gate 111 is turned on. The second power source 122 supplies power to the second light source 102 when the second control gate 112 is turned on. The tuning circuit 13 have multiple settings corresponding to different duty cycles for turning on and turning off the first control gate 111 and the second control gate 112 to generate different mixing optical characteristic of the first light source and the second light source.

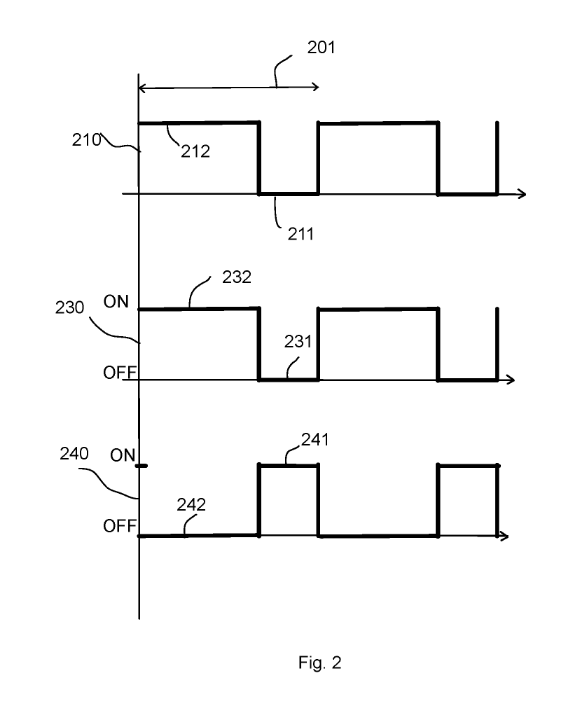

Please refer to FIG. 2, which illustrates control timing diagram via a PWM approach. PWM, or pulse-duration modulation (PDM), is a modulation technique used to encode a message into a pulsing signal. The PWM signal is a series of pulses. For each pulse (i.e., each period or cycle), the pulse includes a portion of “high” signal and a portion of “low” signal. In one embodiment, the time period may be 1/1000 second between two consecutive high levels of the PWM signal.

In FIG. 2, the PWM signal 210 is a square wave with a time period 201. The PWM signal has a high level 212 and a low level 211, with respect to electrical voltage level. The PWM signal 210 is used for generating a first control signal 230 and a second control signal 240. The first control signal 230 is used for turning on and turning off the first light source. The second control signal 240 is used for turning on and turning off the second light source. It is indicated in FIG. 2 that when the PWM signal 210 is at high level 210, the first control signal 230 sends a turn-on signal 232 to turn on the first light source. When the PWM signal 210 is at low level 211, the first control signal 230 sends a turn-off signal 231 to the first light source to turn off the first light source. On the other hand, when the PWM signal 210 is at high level 210, the second control signal 240 sends a turn-off signal 242 to turn off the second light source. When the PWM signal 210 is at low level 211, the second control signal 240 sends a turn-on signal 241 to the second light source to turn on the second light source.

Please be noted that the first power source and the second power source may be two distinct power sources but may also refer to two parts of one physical power source. In addition, the first power source and the second power source may even be referred to the same power source. In one embodiment, for example, the first light source and the second light source are not turned on at the same time. In other words, for any moment, only one light source is turned on and therefore a single power source may be used as the first power source and the second power source alternatingly.

In one embodiment, the first light source and the second light source are LED (Light Emitted Diode) modules, e.g. a LED chip or a module with multiple LED chips. The first light source and second light source may have different color temperatures. By adjusting the turn-on to turn-off ratio of the first light source corresponding to the second light source therefore may change the visual effect of mixing color temperature. Color mixing may also be used with the technical solutions mentioned in this disclosure.

In one embodiments, the first light source and the second light source respectively have multiple LED modules arranged with an interlaced pattern to each other so that when the first light source and the second light source may provide a more stable mixing effect.

In one embodiment, the first control gate and the second control gate are MOSFET switches respectively receiving a first control signal and a second control signal from the tuning circuit to turn on or to turn off the first light source and the second light source.

In one embodiment, when the first light source is turned on, the second light source is turned off. In addition, when the second light source is turned on the first light source is turned off.

In one embodiment, the first control signal and the second control signal are PWM (Pulse Width Modulation) signals provided by the tuning circuit.

In PWM case, the first control signal may refer the high level as turn-on while the second control signal may refer the low level as turn-on. In addition, the first control signal may refer the low level as turn-off while the second control signal may refer the high level as turn-off. By disposing an inverter or related circuit, the first control signal and the second control signal may have the same signal source, e.g. a PWM signal. Please be noted, however, such configuration is only one of the methods to implement the present invention and therefore, the present invention is not limited by such implementation.

In one embodiment, there are more than three settings, each setting corresponding to a different duty cycle with different turn-on by turn-off ratios for the first control signal and the second control signal. For example, the tuning circuit has a switch selectively connected to one of five resistors to construct one of five selective electrical signal values to generate a corresponding PWM signal from five options to control the first light source and the second light source. In such example, there are five settings, which means the first light source and the second light source may be controlled to generate five different optical characteristics, e.g. five different color temperatures.

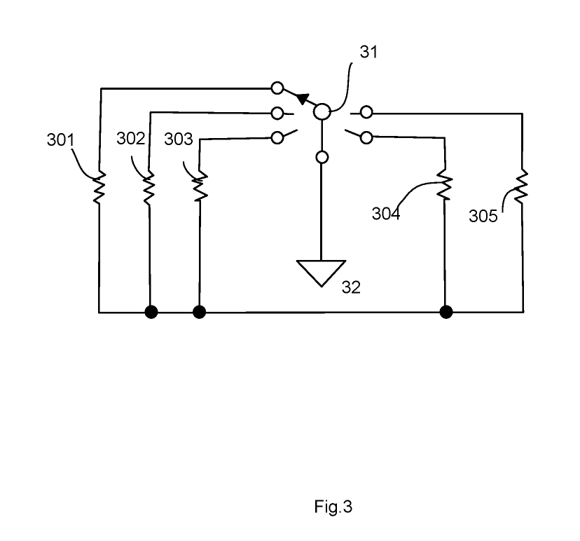

Please refer to FIG. 3, which illustrates a portion of a driving circuit in a light apparatus. Since persons of ordinary skilled in the art know how to implement a common light apparatus driver, common circuits are not mentioned here for simplicity.

In FIG. 3, the switch 31, which may be a digital or a mechanical device for selectively connecting to five different resistors 301, 302, 303, 304, 305 to generate different signal value to supply to a tuning circuit 32.

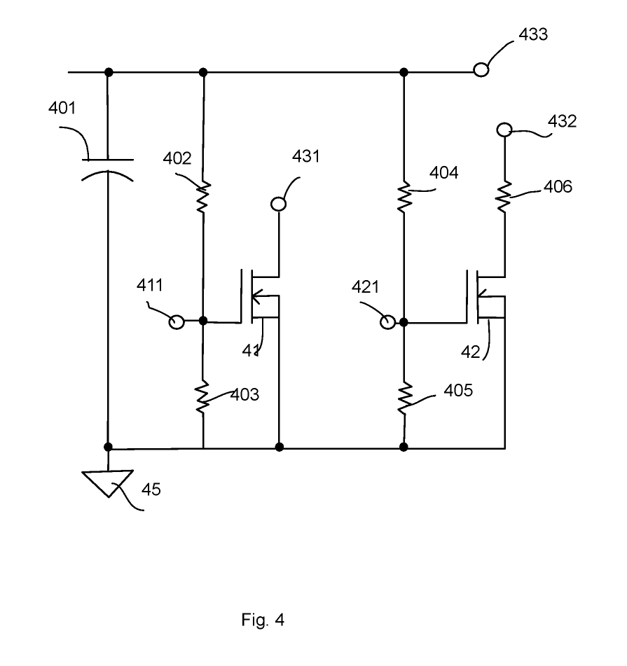

FIG. 4 illustrates a circuit example, not to limit the present invention but used for explaining at least one way to implement the inventive concept.

In FIG. 4, several passive components 401, 402, 403, 404, 405, 406 are used together with two MOSFET gates 41 and 42. The two MOSFET gates 41, 42 receives two control signals 411, 421, as mentioned above to turn on or turn off power source to a first light source and a second light source. In FIG. 4, the nodes 431, 432 are selectively connected to 433 to select one of the first light source and the second light source to get power supply to turn on. The circuits in FIG. 4 is further connected to other portion of a driver circuit 45 to complete the driving function.

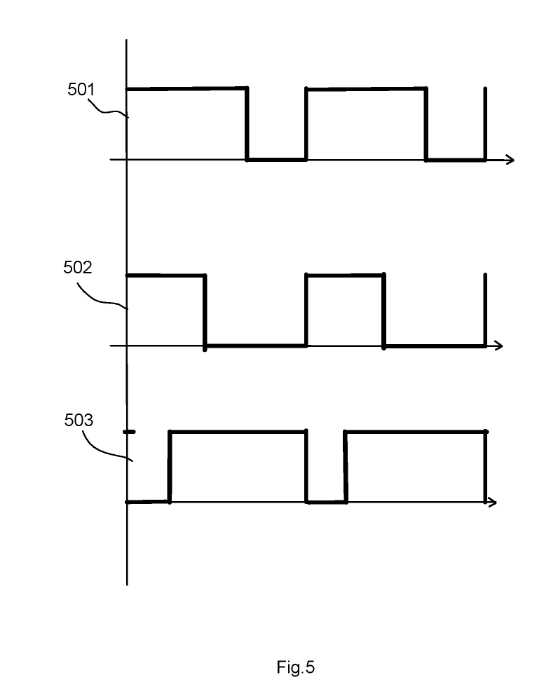

Please refer to FIG. 5, which illustrate three settings in a PWM driven example of an adjustable light apparatus.

In FIG. 5, three PWM signals 501, 502, 503 having different high level to low level ratios. As mentioned above, such settings may cause different turn-on ratios between the first light source and the second light source.

Please be noted that the example is not used to limit the present invention. Persons of ordinary skilled in the art may amend the design for implementing the present invention. For example, turn-on and turn-off switching between the first light source and the second light source may depend on rising and falling edges of a periodic signal. Alternatively, the numbers of a periodic wave may be allocated respectively to turn on the first light source and the second light source. Specifically in such example, two high levels may be allocated to turn on the first light source while another consecutive four high levels may be allocated to turn on the second light source. Other variations, under such teaching, are supposed to be understood and enabling for persons of ordinary skilled in the art.

In some other embodiments, the tuning of the setting may be continuous, instead of selection from several discrete options. For example, a dimmer, e.g. along with an adjustable resistor, may be used to generate a corresponding voltage provided to a PWM generator to generate an associated PWM signal over a continuous range.

In one embodiment, the adjustable light apparatus may include an operation switch sending a tuning operation of a user to the tuning circuit to change the mixing optical characteristic of the first light source and the second light source. For example, a dimmer that is operable by a user may be used to select a setting, and the dimmer, like a rotatable button, may be connected to the tuning circuit to change the setting of driving the first light source and the second light source.

In addition to the first light source and the second light source, in other embodiments, there may be other light sources disposed. For example, a third light source, or even more, may be disposed along with the first light source and the second light source. In such case, the first light source, the second light source, and the third light source may have different color temperatures. Under different settings, the first light source, the second light source and the third light source may be turned sequentially with different time period ratios to generate a different overall color temperature.

In one embodiment, the adjustable light apparatus has a downlight housing for disposing the first light source, the second light source, the control circuit and the tuning circuit. Such downlight housing may include a reflector, a heat sink, a driver circuit, and other corresponding components to be installed on a ceiling cavity. On such housing, there may be a mechanic switch, e.g. an adjustable lever, for a user to slide to set a corresponding setting for generating a different optical characteristic, e.g. a different color temperature. Such mechanic switch may be combined with associated components to instruct the tuning circuit to change the settings of the tuning circuit.

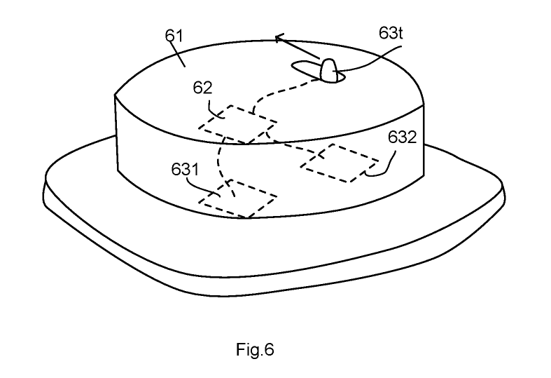

Please refer to FIG. 6, which illustrates a downlight device as an embodiment of the present invention. In FIG. 6, a lever 631 may be moved by a user to change the setting of the tuning circuit 62 to change how to switch between a first light source 631 and a second light source 632.

In one embodiment, the adjustable light apparatus has a wireless circuit connected to the tuning circuit for receiving a control instruction from an external device to change the setting of the tuning circuit. For example, a user may use a Wi-Fi device or a Bluetooth device on a mobile phone to send a control signal to the wireless circuit of the adjustable light apparatus to control the tuning circuit to change a desired setting to get a desired overall optical characteristic of the adjustable light apparatus.

In one embodiment, the tuning circuit and the control circuit are integrated in an integrated chip mounted on a circuit board connected to a heat sink. These circuits may generate massive heat and such arrangement may help lengthen the life span and increase system liability.

As mentioned above, there may be more than one optical characteristic to be mixed. For example, the optical characteristic may include color spectrum distribution. In other words, the first light source and the second light source may emit different light colors. By adjusting their turn-on and turn-off ratio may be used to generate a different color effect. In addition to color, luminance strength may also be a factor to be adjusted. For example, the first light source and the second light source may have different luminance levels, e.g. one emits brighter and consumes more power than the other. By adjusting to different settings, users may easily get the desired light effect they need.

In one embodiment, the turn-on periods of the first light source and the second light source are partially overlapped. In such case, the first light source and the second light source may have a common turn-on period instead of a strict alternating pattern. Such design may increase a better visual effect. In such design, certain capacitor may be used to store the increased power source to keep the overall power source not varying too much.

In one embodiment, there may be a time gap between turn-on periods of the first light source and the second light source. For example, when the first light source is turned off, there is a time gap before the second light source is turned on. Such time gap may help keep the power source stable, avoiding undesired peak to damage the power circuit.

In one embodiment, the settings are stored in a table of the tuning circuit and the table is adjustable. For example, the tuning circuit has a corresponding memory unit for storing optional values of the settings. A designer may change the values of the memory unit to change a different value. In such design, a common configuration may have better flexibility. For example, light apparatuses sold to different regions, having different needs and requirements, may use the same hardware settings but loaded with different setting values.

In one embodiment, the first light source and the second light source may not need to be always turned on and then turn off sequentially. For example, the first light source may be kept turned on. By changing the turn-on periods of the second light source, the overall optical characteristic, like color temperature, may still be adjusted under different settings.

In one embodiment, when one of the first light source and the second light source is damaged, the other light source may be kept turned on. In other words, the other light source may be used a redundant backup solution even when one light source is damaged. In such design, an operable switch or an automatic sensor may be used for the tuning circuit to operate under predetermined circuit logic.

In addition to the above-described embodiments, various modifications may be made, and as long as it is within the spirit of the same invention, the various designs that can be made by those skilled in the art are belong to the scope of the present invention.

1. An adjustable light apparatus, comprising:
a first light source;
a second light source, the first light source and the second light source having different optical characteristic;
a control circuit coupled to the first light source and the second light source, the control circuit having a first control gate and a second control gate respectively connected to a first power source and a second power source, the first power source supplying power to the first light source when the first control gate being turned on and the second power source supplying power to the second light source when the second control gate being turned on, wherein the control circuit generates a PWM signal for generating a first control signal and a second control signal, when the PWM signal is at a high stage, the first control signal is turned on to turn on the first control gate and the second control signal is turned off to turn off the second control gate, when the PWM signal is at low stage, the first control signal is turned off to turn off the first control gate and the second control signal is turned on to turn on the second control gate; and
a tuning circuit with multiple settings corresponding to different duty cycles for turning on and turning off the first control gate and the second control gate to generate different mixing optical characteristic of the first light source and the second light source by adjusting a duty ratio of the PWM signal.

2. The adjustable light apparatus of claim 1, wherein the first light source and the second light source are LED (Light Emitted Diode) modules having different color temperatures.

3. The adjustable light apparatus of claim 1, wherein the first control gate and the second control gate are MOSFET switches respectively receiving a first control signal and a second control signal from the tuning circuit to turn on or to turn off the first light source and the second light source.

4. The adjustable light apparatus of claim 3, wherein when the first light source is turned on, the second light source is turned off.

5. The adjustable light apparatus of claim 4, wherein the first control signal and the second control signal are PWM (Pulse Width Modulation) signals provided by the tuning circuit.

6. The adjustable light apparatus of claim 5, wherein there are more than three settings, each setting corresponding to a different duty cycle with different turn-on by turn-off ratios for the first control signal and the second control signal.

7. The adjustable light apparatus of claim 5, wherein the tuning circuit has a switch for selectively connected to five resistors to change to five different settings for controlling the first light source and the second light source.

8. The adjustable light apparatus of claim 1, further comprising an operation switch sending a tuning operation of a user to the tuning circuit to change the mixing optical characteristic of the first light source and the second light source.

9. The adjustable light apparatus of claim 1, further comprising a third light source having a different optical characteristic from the first light source and the second light source.

10. The adjustable light apparatus of claim 1, further comprising a downlight housing for disposing the first light source, the second light source, the control circuit and the tuning circuit.

11. The adjustable light apparatus of claim 10, further comprising a mechanic switch disposed on the downlight housing to be operated by a user to change the setting of the tuning circuit.

12. The adjustable light apparatus of claim 1, further comprising a wireless circuit connected to the tuning circuit for receiving a control instruction from an external device to change the setting of the tuning circuit.

13. The adjustable light apparatus of claim 1, wherein the tuning circuit and the control circuit are integrated in an integrated chip mounted on a circuit board connected to a heat sink.

14. The adjustable light apparatus of claim 1, wherein the optical characteristic comprises color spectrum distribution.

15. The adjustable light apparatus of claim 1, wherein the optical characteristic comprises luminance.

16. The adjustable light apparatus of claim 1, wherein the turn-on periods of the first light source and the second light source are partially overlapped.

17. The adjustable light apparatus of claim 1, wherein there is a time gap between turn-on periods of the first light source and the second light source.

18. The adjustable light apparatus of claim 1, wherein the settings are stored in a table of the tuning circuit and the table is adjustable.

19. The adjustable light apparatus of claim 1, wherein the first light source is always kept turned on.

20. The adjustable light apparatus of claim 1, wherein when one of the first light source and the second light source is damaged, the other light source is kept turned on.
